(19) United States
(12) Patent Application Publication
(10) Pub. No.: US 2021/0221550 A1
(43) Pub. Date: Jul. 22, 2021

(54) GLASS CONTAINER FOR PHARMACEUTICAL, MEDICAL OR COSMETIC APPLICATIONS

(71) Applicant: SCHOTT AG, Mainz (DE)

(72) Inventors: Stephanie Mangold, Schornsheim (DE); Oliver Fratzer, Egelsbach (DE); Andrea Anton, Hüffelsheim (DE); Eveline Rudigier-Voigt, Mainz (DE); Michael Waschbüsch, Undenheim (DE)

(73) Assignee: SCHOTT AG, Mainz (DE)

(21) Appl. No.: 17/150,737

(22) Filed: Jan. 15, 2021

(30) Foreign Application Priority Data
Jan. 16, 2020 (DE) 20 2020 100 215.5
Jan. 16, 2020 (DE) 20 2020 100 219.8
Jan. 17, 2020 (DE) 20 2020 100 245.7

(51) Int. Cl. B65D 1/02; C03C 17/30; B65D 23/08; A61J 1/14

(52) U.S. Cl. CPC B65D 1/0215; C03C 17/30; C03C 2217/78; A61J 1/1468; B65D 23/0821

(57) ABSTRACT

A glass container includes a hollow body of a glass material. The hollow body surrounds an inner volume and has a lower end and an upper end. A container opening extends through the upper end into the inner volume. The hollow body further includes a container collar surrounding the container opening, a container neck, a container shoulder, a container body, a container bottom closing the lower end, and an inner container surface facing the inner volume and an outer container surface facing away from the inner volume. The glass container is coated on its outer container surface at least partially with a coating and the coated glass container has an increased scratch resistance with respect to a contact of the glass container with at least one further glass container.

### CROSS REFERENCE TO RELATED APPLICATIONS

This application claims priority to German Patent Application No. DE 20 2020 100 245.7 filed on Jan. 17, 2020, which is incorporated in its entirety herein by reference. This application also claims priority to German Patent Application No. DE 20 2020 100 219.8 filed on Jan. 16, 2020, which is incorporated in its entirety herein by reference. This application also claims priority to German Patent Application No. DE 20 2020 100 215.5 filed on Jan. 16, 2020, which is incorporated in its entirety herein by reference.

### BACKGROUND OF THE INVENTION

### 1. Field of the Invention

The present invention relates to a glass container for pharmaceutical, medical or cosmetic applications.

### 2. Description of the Related Art

Glass containers which are used as packaging material for pharmaceutical, medical or cosmetic applications are usually subjected to further processing steps after their hot forming before they are finally filled or distributed. Typical processing steps after hot forming are, for example, washing, followed by drying or sterilization to meet the high requirements, such as low particle load or sterility of the glass containers, for pharmaceutical, medical or cosmetic applications.

However, a drawback of such processed, known glass containers is that the glass containers usually exhibit scratches or at least slightest damage on their surface due to direct contact with their environment, such as system components or other glass containers, which might act as initial defects for breakage and can lead to a reduced strength of the glass containers. A further drawback of scratches or damage to the container surface is the loss of the flawless optical impression of the glass containers. A further drawback of such processed, known glass containers can be the presence of undesirable substances inside the glass container, which is undesirable in view of their pharmaceutical, medical or cosmetic use.

What is needed in the art is a way to provide a glass container, which has an increased strength and an improved, such as flawless, optical impression and to provide a glass container which has an increased strength and at the same time is free from undesirable substances on the container inside, and to avoid cosmetic defects.

### SUMMARY OF THE INVENTION

Exemplary embodiments provided according to the present invention provide a glass container, such as a vial for pharmaceutical, medical or cosmetic applications, which, in particular, is manufactured or manufacturable by a method specified further herein.

In some exemplary embodiments provided according to the present invention, a glass container includes a hollow body of a glass material. The hollow body surrounds an inner volume and has a lower end and an upper end. A container opening extends through the upper end into the inner volume. The hollow body further includes a container collar surrounding the container opening, a container neck, a container shoulder, a container body, a container bottom closing the lower end, and an inner container surface facing the inner volume and an outer container surface facing away from the inner volume. The glass container is coated on its outer container surface at least partially with a coating and the coated glass container has an increased scratch resistance with respect to a contact of the glass container with at least one further glass container.

In some exemplary embodiments provided according to the present invention, a glass container for pharmaceutical, medical or cosmetic applications includes a hollow body of a glass material. The hollow body surrounds an inner volume and has a lower end and an upper end. A container opening extends through the upper end into the inner volume. The hollow body further includes a container collar surrounding the container opening, a container neck, a container shoulder, a container body, a container bottom closing the lower end, and an inner container surface facing the inner volume and an outer container surface facing away from the inner volume. The glass container is coated on its outer container surface at least partially with a coating. The outer container surface is partially uncoated such that the glass material of the hollow body is exposed over an uncoated partial area of the outer container surface. The inner container surface is completely uncoated such that the glass material of the hollow body is exposed over the entire inner container surface. The coating covering the outer container surface in a region of a coated partial area is characterized by an adhesion to the glass material or is configured such that no migration of coating material onto the inner container surface occurs after storage of the container for at least 1 week.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A illustrates a schematic illustration of a glass container;

FIG. 1B illustrates a schematic illustration of a glass container at least partially coated with a coating on its outer container surface;

FIG. 2 illustrates a schematic illustration of a glass container in a laboratory shaker which is in contact with other glass containers;

FIG. 3 shows photographs taken with 10x focus of a glass container provided according to the present invention and a known glass container after contact with other glass containers for four periods of time;

FIG. 4 illustrates measurement results presented as a diagram of the spectral transmittance of a known glass container;

FIG. 5 illustrates measurement results presented as a diagram of the spectral transmittance of a glass container provided according to the present invention,

FIG. 6 shows photographs of a glass container in a device for determining the spectral transmittance;

FIG. 7 illustrates measurement results presented as a diagram of the contact angle of hexadecane on the outer container surface of a glass container provided according to the present invention and on the outer container surface of a known glass container;

FIG. 8 illustrates measurement results presented as a diagram of the contact angle of water on the outer container surface of a glass container provided according to the present invention and on the outer container surface of a known glass container;

FIG. 9 shows a photograph of a sawn glass container with marked test points on the inner container surface;

FIG. 10 illustrates measurement results presented as a diagram of specific depth profiles of selected secondary ions on the outer container surface at the bottom, acquired using secondary ion mass spectrometry (ToF-SIMS);

FIG. 11 illustrates measurement results presented as a diagram of specific depth profiles of selected secondary ions on the outer container surface at the container body at the center, acquired using secondary ion mass spectrometry (ToF-SIMS); and

FIG. 12 shows measurement results presented as a diagram of specific depth profiles of selected secondary ions on the inner container surface at the container body at the center, acquired using secondary ion mass spectrometry (ToF-SIMS).

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The glass container provided according to the present invention includes a hollow body of a glass material, the hollow body surrounding an inner volume and having a lower end and an upper end. A container opening extends through the upper end into the inner volume.

Furthermore, the hollow body includes a container collar surrounding the container opening, a container neck, a container shoulder, a container body, a container bottom closing the lower end, as well as an inner container surface facing the inner volume and an outer container surface facing away from the inner volume. The container body is to be understood, in particular, as the cylindrical section of a glass container.

The glass container provided according to the present invention is characterized in that the glass container is coated on its outer container surface at least partially with a coating.

In some embodiments, the glass container has an increased scratch resistance, in particular with respect to a contact of the glass container with at least one further glass container. The coating applied at least partially on the outer surface of the container and the resulting increased scratch resistance is useful in ensuring increased strength of the glass container and at the same time improves the optical impression.

In some embodiments, the glass container may have a transmittance for light with a wavelength of 350 nm which is higher than 0.7, such as higher than 0.71, higher than 0.72, higher than 0.73, or higher than 0.74.

Further, the glass container may have a transmittance for light with a wavelength of 550 nm which is higher than 0.73, such as higher than 0.74, higher than 0.75, s higher than 0.76, or higher than 0.77.

The glass container may also have a transmittance for light with a wavelength of 750 nm which is higher than 0.74, such as higher than 0.75, higher than 0.76, higher than 0.77, or higher than 0.78.

The transmittance may be measurable at least at one point in the region of the container body, such as directly above the container bottom or directly below the container shoulder, and particularly at any point in the region of the container body, in particular when the light passes radially and centrally through the glass container such that the light first passes through the hollow body, then through the inner volume and then again through the hollow body.

The glass container may exhibit the aforementioned transmittance after contact of the glass container with at least one further glass container.

In some embodiments, the glass container may have a yellowness index which is lower than 2.5, such as lower than 2.0, lower than 1.5, lower than 1.25, or lower than 1.0.

The yellowness index may be measurable at least at one point in the region of the container body, such as directly above the container bottom or directly below the container shoulder, and at any point in the region of the container body, according to ASTM D1925-70, in particular when the light passes radially and centrally through the glass container such that the light first passes through the hollow body, then through the inner volume and then again through the hollow body.

The glass container may exhibit the yellowness index after contact of the glass container with at least one further glass container.

In some embodiments, the outer container surface of the glass container may have a mean roughness Rₐ which is lower than 20 nm, such as lower than 15 nm, lower than 10 nm, lower than 5 nm, or lower than 2.5 nm.

The mean roughness value Rₐ may be measurable at least at one point in the region of the container body, such as directly above the container bottom or directly below the container shoulder, and at each point in the region of the container body, such as by white light interference microscopy.

The glass container may exhibit the mean roughness Rₐ after contact of the glass container with at least one further glass container.

The contact of the glass container with at least one further glass container may comprise a contact in which the container body of the glass container is in contact with the container body of at least one further glass container of the same type, and the at least two glass containers may have been shaken for a period of at least 5 minutes, such as at least 10 minutes or at least 30 minutes, in particular in the radial direction. The shaking of the at least two glass containers may be performed by a laboratory shaker, for example with a shaking frequency of 400 rpm and an amplitude of 1 cm.

The contact may further comprise that, before the shaking, the glass containers were heated for 1 min to 60 min, such as 10 min to 50 min, 20 min to 40 min, or 30 min, to 100° C. to 600° C., such as 200° C. to 500° C., 300° C. to 400° C., or 350° C.

The contact may further comprise that, between the heating and the shaking less than 8 hours, such as less than 5 hours, less than 3 hours, or less than 1 hour, have/has passed.

The contact may further comprise that, before the heating, the glass containers were immersed in a bath of water, such as distilled water, at a temperature of 40° C. to 100° C., such as 50° C. to 95° C., 60° C. to 90° C., or 80° C., for 1 s to 20 min, such as 1 min to 15 min, 3 min to 10 min, or 5 min.

Furthermore, a glass container may be provided which, after passing through a test program, meets one or more of the following parameters:

the glass container has a transmittance for light with a wavelength of 350 nm which is higher than 0.7, such as higher than 0.71, higher than 0.72, higher than 0.73, or higher than 0.74; and/or

the glass container has a transmittance for light with a wavelength of 550 nm which is higher than 0.73, such as higher than 0.74, higher than 0.75, higher than 0.76, or higher than 0.77; and/or

the glass container has a transmittance for light with a wavelength of 750 nm which is higher than 0.74, such as higher than 0.75, higher than 0.76, higher than 0.77, or higher than 0.78;

the transmittance being measurable at least at one point in the region of the container body, such as directly above the container bottom or directly below the container shoulder, and at any point in the region of the container body, in particular when the light passes radially and centrally through the glass container such that the light first passes through the hollow body, then through the inner volume and then again through the hollow body; and/or

the glass container has a yellowness index which is lower than 2.5, such as lower than 2.0, lower than 1.5, lower than 1.25, or lower than 1.0;

the yellowness index is measurable at least at one point in the region of the container body, such as directly above the container bottom or directly below the container shoulder, and at any point in the region of the container body, according to ASTM D1925-70, in particular when the light passes radially and centrally through the glass container such that the light first passes through the hollow body, then through the inner volume and then again through the hollow body; and/or

the outer container surface of the glass container has a mean roughness Rₐ which is lower than 20 nm, such as lower than 15 nm, lower than 10 nm, lower than 5 nm, or lower than 2.5 nm;

the mean roughness Rₐ is measurable at least at one point in the region of the container body, such as directly above the container bottom or directly below the container shoulder, and at each point in the region of the container body, such as by white light interference microscopy; and

running through the test program comprises the following steps: heating the glass containers to 350° C. for 30 minutes, bringing the glass container into contact with at least one further glass container so that the container body of the glass container is in contact with the container body of at least one further glass container of the same type, and shaking the at least two glass containers for a period of at least 5 minutes, such as 10 minutes or 30 minutes, in particular in the radial direction, wherein the shaking of the at least two glass containers may be performed by a laboratory shaker, for example with a shaking frequency of 400 rpm and an amplitude of 1 cm, wherein the bringing in contact and shaking is performed within 1 h after heating, and optionally immersing the glass containers in a bath of water, which may be distilled water, with a temperature of 80° C. for 5 min, the immersing taking place before heating.

The coating with which the outer container surface is at least partially coated may comprise a silicone. In some embodiments, the coating is recommended by the German Federal Institute for Risk Assessment (BfR) for contact with foodstuffs and/or approved as a medical product by the German Federal Office for Drugs and Medical Devices (BfArM). Further, the coating may be formed as a dried silicone emulsion, which, may be post-cured. The coating may be manufactured and/or manufacturable according to a coating method and/or with a coating material as described further herein.

Furthermore, the outer container surface may be coated with the coating such that the glass material of the hollow body is covered with the coating within a coated partial area of the outer container surface.

Accordingly, the glass material of the hollow body can be covered with a coating in the region of the coated partial surface of the outer container surface, wherein not necessarily the entire region of the coated partial surface needs to be covered with a coating. Instead, it is also possible that there are insular gaps within the coated partial surface, e.g. at the container bottom or elsewhere.

The coated partial surface of the outer container surface, in whose area the glass material is covered with a coating, may enclose the region of the container body and/or the region of the container bottom at least partially, such as completely.

Furthermore, the outer container surface may be coated with the coating such that the outer container surface is partially uncoated such that the glass material of the hollow body is exposed over an uncoated partial area of the outer container surface.

The uncoated partial area of the outer container surface may correspond to the entire outer container surface minus the coated partial area of the outer container surface.

The uncoated partial area of the outer container surface may completely enclose the region of the container collar and, in some embodiments, the region of the container neck and may enclose the region of the container shoulder at least partially, such as completely.

Furthermore, the glass container may be configured such that the inner container surface is completely uncoated such that the glass material of the hollow body is exposed over the entire inner container surface.

Accordingly, the inner container surface may be completely exposed, i.e. such as over the area of the container bottom, the area of the container body, the area of the container shoulder, the area of the container neck and the area of the container collar.

In some embodiments, the coating covering the outer container surface in the region of the coated partial area may be characterized by an adhesion to the glass material or configured such that no migration of coating material onto the inner container surface occurs, such as after storage of the container for at least 1 week, such as at least 3 weeks, or at least 6 weeks.

For example, a glass container provided according to the present invention may comprise a hollow body of a glass material, the hollow body surrounding an inner volume and having a lower end and an upper end, and a container opening extends through the upper end into the inner volume. The hollow body further comprises a container collar surrounding the container opening, a container neck, a container shoulder, a container body, a container bottom closing the lower end, and an inner container surface facing the inner volume and an outer container surface facing away from the inner volume. The glass container is characterized on the one hand in that the outer container surface is partially coated such that the glass material of the hollow body is covered with a coating in the area of a coated partial surface of the outer container surface and that the outer container surface is partially uncoated such that the glass material of the hollow body is exposed over an uncoated partial surface of the outer container surface. The inner container surface is completely uncoated such that the glass material of the hollow body is exposed over the entire inner container surface.

The coating, which covers the outer container surface in the region of the container body, has at least at one point an equivalent thickness related to the glass material of less than 50 nm, such as of less than 25 nm, of less than 10 nm, or of less than 5 nm.

Further, the coating, which covers the outer container surface in the region of the container bottom, has at least at one point an equivalent thickness with respect to the glass material of less than 200 nm, such as of less than 100 nm, of less than 50 nm, or of less than 25 nm.

The previously mentioned equivalent thickness with respect to the glass material is determinable by determining a sputter rate by secondary ion mass spectrometry (ToF-SIMS) on the basis of a reference glass and using this sputter rate for evaluating the secondary ion mass spectrometry of the coating.

Specifically, the sputter rate can be determined using BK7 as the reference glass and using Cs, 2 keV as the sputtering parameter. For this purpose, the ion current and the grating area can first be noted and a sputter crater can be generated. Then the depth of the sputter crater can be measured, e.g. with white light interferometry (WLI), to obtain a sputter rate, for example in the unit nm/s, especially for BK7 depending on ion current and grating area.

When a depth profile of the coating is acquired, i.e. a depth profile is measured on the coated glass container, the sputtering time can be converted directly into an equivalent depth for the same ion current and grating area. If the ion current deviates, the equivalent depth increases proportionally to the current; if the area deviates, the equivalent depth is antiproportional to the area.

The previously mentioned equivalent thickness of the coating, which covers the outer container surface in the region of the container body, may be given at least at one point. It may also be provided that the equivalent thickness is given over an area proportion of the container body of at least 90 percent, such as at least 95 percent or at least 99 percent.

Likewise, the equivalent thickness of the coating, which covers the outer container surface in the region of the container bottom, may be given over an area proportion of the container bottom of at least 90 percent, such as at least 95 percent or at least 99 percent.

The equivalent thickness of the coating which covers the outer container surface in the region of the container body and the equivalent thickness of the coating which covers the outer container surface in the region of the container bottom may be in a ratio to one another which is in the range from 1:10 to 10:1, such as in the range from 1:10 to 1:1 or in the range from 1:1 to 10:1.

As explained in more detail further herein, the coated partial surface of the outer container surface may form a contact angle between 10 and 12 degrees with respect to hexadecane and/or may form a contact angle between 90 and 120 degrees with respect to water.

The uncoated partial surface of the outer container surface and, in some embodiments, the entire inner container surface may form a contact angle of less than 10 degrees with respect to hexadecane and/or may form a contact angle of less than 10 degrees with respect to water.

In some embodiments, the glass container and/or the glass material is of a type selected from the group consisting of a borosilicate glass, an aluminosilicate glass, soda lime glass and fused silica. “Soda lime glass” according to the present invention is an alkaline/alkaline earth/silicate glass according to table 1 of ISO 12775 (1st edition 1997-10-15).

The glass container as described previously may be manufactured or manufacturable by a method described below.

The method includes that a plurality of glass containers is simultaneously subjected to a first processing step and thereafter the plurality of glass containers is simultaneously subjected to a second processing step. Before and/or during the first and/or second processing step the outer container surface of the glass container is contact-free or in contact with a material having a lower hardness than that of the glass container or only in contact with such materials.

In some embodiments, before and/or during the first and/or second processing step less than 20 percent of the outer container surface, such as less than 10 percent of the outer container surface, less than 5 percent of the outer container surface, or less than 2 percent of the outer container surface is in contact with a material, such as a material having a lower hardness than that of the glass container.

The part of the outer container surface that may come into contact with a material may be located at the upper end of the glass container, such as above the container shoulder and, for example, at the container neck and/or the container collar.

In some embodiments, the contact provides for holding the glass container, such as at its upper end, which may be at its container collar and/or its container neck, such that the glass container is secured by the container collar against a downward movement.

In some embodiments, each glass container of the plurality of glass containers is held individually and without contact with respect to the other glass containers.

In some embodiments, the method further comprises that before and/or during the first and/or second processing step, the inner container surface of the glass container is contact-free, such as by sealingly closing the container opening of the glass containers in order to prevent substances from penetrating into the inner volume, to prevent penetration of liquids and solids into the inner volume, and also to prevent penetration of gases or gaseous compounds into the inner volume.

Furthermore, a third, a fourth and possibly even more processing steps may be included, wherein before and/or during the third, fourth and/or further processing steps, the outer container surface of the glass container is contact-free or in contact with a material having a lower hardness than that of the glass container or only in contact with such materials and, in some embodiments, the inner container surface of the glass container is contact-free, such as by sealingly closing the container opening of the glass containers in order to prevent substances from penetrating into the inner volume.

In some embodiments, each processing step the plurality of glass containers is simultaneously processed, such as in an individual processing station.

In some embodiments, in each processing step the plurality of glass containers is simultaneously held by a capturing device, which may be adapted to simultaneously capture and hold the plurality of glass containers.

For example, the method may comprise that the plurality of glass containers is simultaneously cleaned, such that the outside surface of the glass containers is cleaned with a cleaning fluid and/or the plurality of glass containers is simultaneously coated such that the outer container surface of the glass containers is coated with a coating material, the coating may be performed after the cleaning, the cleaning being the first processing step, and the coating being the second processing step, and before and/or during the cleaning and/or coating the outer container surface of the glass container is contact-free or in contact with a material having a lower hardness than that of the glass container or only in contact with such materials and, in some embodiments, the inner container surface of the glass container is contact-free, such as by sealingly closing the container opening of the glass containers.

The cleaning of the glass containers may comprise ultrasonic cleaning.

The coating of the glass containers may be performed by dipping the glass container into a coating material, which may comprise silicone or an emulsion with silicone and water, such as a silicone emulsion.

The coating material may, for example, be a silicone emulsion with a silicone content between 0.4 and 7 weight percent of the silicone emulsion or comprise such a silicone emulsion. In some embodiments, the coating material, such as the emulsion, also includes solvents, such as propylene glycol. The coating material, which may be the silicone emulsion, may be formed such that it post-cures under the influence of temperature.

Due to the requirements for the pharmaceutical, medical or cosmetic application of coated glass containers, the coating material, such as the silicone, may be recommended by the German Federal Institute for Risk Assessment (BfR) for contact with foodstuffs and may be approved as a medical product by the German Federal Office for Drugs and Medical Devices (BfArM),

The coating material may, for example, comprise a 35% dimethicone emulsion, wherein the coating material may also include water. Specifically, the coating material may comprise the Dow Corning® 365, 35% Dimethicone NF emulsion and/or the Dow Corning® 366 35% Dimethicone NF emulsion.

In some embodiments, the glass containers are first dipped with the container bottom into the coating material and then further up to an upper limit, in particular at an upper edge of the glass containers, wherein the upper limit may be located in the area of the container shoulder, such as in the transition area from the container shoulder to the cylindrical container body.

Furthermore, the glass containers may be removed again from the coating material, wherein, subsequently, the coating may be homogenized, for example by removing or smoothing a drop of coating material formed at the container bottom. To this end, the plurality of glass containers, such as their outer container surface such as the container bottom, may be dipped into a solvent or advanced to the surface of a solvent or advanced to a smoothing device.

The homogenization, which may occur after coating the glass containers, such as after removing the glass containers from the coating material, may be a further processing step in which the glass containers are simultaneously processed.

In some embodiments, before and/or during the homogenization the outer container surface of the glass container is contact-free or in contact with a material having a lower hardness than that of the glass container or only in contact with such materials. In some embodiments, the inner container surface of the glass container is contact-free, such as by sealingly closing the container opening of the glass containers.

The method may further comprise drying the coating material, the drying may be a further processing step in which the glass containers are simultaneously processed. During the drying, the outer container surface of the glass container may be contact-free or in contact with a material having a lower hardness than that of the glass container or only in contact with such materials and, in some embodiments, the inner container surface of the glass container is contact-free, such as by sealingly closing the container opening of the glass containers in order to prevent substances from penetrating into the inner volume.

The drying of the coating material may be performed by waiting and/or adding heat. The drying may also be performed by application of vacuum or microwave radiation.

The plurality of glass containers is simultaneously transported between the processing steps, such as by a transport device as described further herein.

In some embodiments, the glass containers are transported such that the outer container surface of the glass container is contact-free or in contact with a material having a lower hardness than that of the glass container or only in contact with such materials and, in some embodiments, the inner container surface of the glass container is contact-free, such as by sealingly closing the container opening of the glass containers in order to prevent substances from penetrating into the inner volume.

In some embodiments, the transport device is adapted to move the capturing device from one processing station to the next processing station such that the plurality of glass containers held by the capturing device is simultaneously transported from one processing station to the next processing station.

The plurality of glass containers may be held during the processing steps and/or during the transporting such that each glass container is held individually and contact-free with respect to the other glass containers, and, in some embodiments, the container opening of the glass containers is sealingly closed, such as by the capturing device as described herein.

It may also be provided that the plurality of glass containers is held continuously during the processing steps and, in some embodiments, further held during transport, and the container opening of the glass containers is sealingly closed meanwhile.

The method as described previously can be carried out by an apparatus for processing, such as for cleaning and coating, glass containers, the apparatus comprising a capturing device, at least two processing stations and a transport device.

The glass containers, which are processed with the apparatus, may be configured as vials for pharmaceutical, medical or cosmetic applications, comprising a hollow body surrounding an inner volume, having a lower end closed by a container bottom, a cylindrical container body, an upper end with a container shoulder, a container neck, a container collar and a container opening which extends into the inner volume of the glass container, and an inner container surface facing the inner volume and an outer container surface facing away from the inner volume.

The capturing device of the apparatus is adapted to simultaneously capture and hold a plurality of glass containers. The capturing device comprises a plurality of individual holding sockets, each adapted to capture and hold one of the glass containers individually and contact-free with respect to the other glass containers.

The at least two processing stations of the apparatus are each adapted to simultaneously subject the plurality of glass containers held by the capturing device to a specific processing step.

Furthermore, the transport device of the apparatus is adapted to move the capturing device from one processing station to the next processing station such that the plurality of glass containers held by the capturing device is simultaneously transported from one processing station to the next processing station.

In some embodiments, the individual holding sockets of the capturing device are each designed to hold the glass container at its upper end, such as at its container collar and/or its container neck, in such a way that the glass container is secured by the container collar against downward movement, for example by the holding sockets clasping the container collar and/or the container neck.

For example, the individual holding sockets of the capturing device can each comprise a first and a second holding body, the two holding bodies being designed to be movable with respect to each other.

In some embodiments, the individual holding sockets of the capturing device are each designed to hold the glass container at its upper end, such as at its container collar and/or its container neck, in such a way that the glass container is secured against downward movement by the container collar, for example by the holding sockets clasping the container collar and/or the container neck.

For example, the individual holding sockets of the capturing device may each comprise a first and a second holding body, the two holding bodies being designed to be movable relative to each other.

In some embodiments, the two holding bodies are designed to be movable apart in such a way that a distance between the two holding bodies can be increased so that the two holding bodies of the holding socket can be placed over the container collar of the glass container from above, wherein the distance can be increased to a limited extent so that the two holding bodies of the holding socket cannot be placed over the container bottom of the glass container from below.

In addition, the two holding bodies may be designed to be movable relative to each other in such a way that the distance between the two holding bodies is reducible again, so that the two holding bodies of the holding socket hold the glass container at its upper end, such as at its container collar and/or its container neck, for example by clasping it.

In some embodiments, the capturing device comprises one or more capturing strips, which each have a first strip arm and a second strip arm, wherein the capturing strips each comprise at least some of the holding sockets, and wherein the first strip arm of a capturing strip forms the first holding bodies of the holding sockets and the second strip arm forms the second holding bodies of the holding sockets.

In some embodiments, the capturing device comprises at least 2 holding sockets, such as at least 10 holding sockets, at least 25 holding sockets, at least 50 holding sockets, or at least 100 holding sockets.

The plurality of holding sockets of the capturing device can be arranged in a regular grid, for example a two-dimensional matrix, in such a way that the capturing device comprises a plurality of, for example, equidistantly arranged, capturing strips each with a plurality of, for example, equidistantly arranged, holding sockets.

For example, the capturing device may comprise at least 2 capturing strips each with at least 2 holding sockets, such as at least 3 capturing strips each with at least 3 holding sockets, at least 5 capturing strips each with at least 5 holding sockets, or at least 7 capturing strips each with at least 7 holding sockets.

In some embodiments, the capturing device has at least one sealing element which can be brought into sealing contact with the upper end of a glass container held by the capturing device, such as the container collar, in such a way that the container opening is sealed tightly in order to prevent the entry of substances into the inner volume, for example during a processing step at one of the processing stations.

The at least one sealing element may be designed such that it can be brought simultaneously into sealing contact with the upper ends of several glass containers held by the capturing device in such a way that the container openings of all these glass containers are simultaneously sealed tightly.

Furthermore, the capturing device may comprise pressing elements adapted to press the upper end of the glass container held by the capturing device and the sealing element against each other in order to bring the upper end of the glass container into sealing contact with the sealing element.

The pressing elements may be designed such that the upper end of the glass container is pressed against the sealing element, which may be fixedly attached to the capturing device, when the capturing device captures the glass container.

The pressing elements can, for example, be designed as an edge of the first and/or second holding body being inclined with respect to the longitudinal axis of a glass container held by the capturing device.

The capturing device, such as its holding sockets, for example its holding body, may comprise a first contact area which comes into contact with the glass container during the capturing and holding of the glass container.

This first contact area can comprise or consist of a material which has a lower hardness than Shore D 95, such as a lower hardness than Shore D 90 or a lower hardness than Shore D 85. A hardness of at least Shore D 40 can be useful. In this respect, reference is made to ISO standard 7619-1. A hardness lower than Brinell 20 may also be used, wherein reference is made to ISO standards 6506-1 to 6506-4.

The first contact area may comprise or consist of a material recommended by the German Federal Institute for Risk Assessment (BfR) for contact with foodstuffs.

Furthermore, the first contact area may comprise or consist of one of the following materials: PU, PVC, rubber, silicone, fluorosilicone, PTFE or a similar material, wherein the material can be a bulk material or a foam.

The sealing element may have a second contact area, which comes into contact with the glass container when capturing and holding the glass container.

This second contact area may include or consist of a material which is less hard than Shore A 75, such as less hard than Shore A 65.

Further, the second contact area may include or consist of a material recommended by the German Federal Institute for Risk Assessment (BfR) for contact with foodstuffs.

The second contact area may also include or consist of one of the following materials: PU, PVC, rubber, silicone, fluorosilicone, PTFE or a similar material, wherein the material can be a bulk material or a foam.

The sealing element and the second contact area can at least partially consist of the same material, or consist of the same material.

In the following, some examples of possible processing stations of the apparatus provided according to the present invention are described.

Accordingly, the apparatus may comprise a processing station designed as a washing station for simultaneously washing the plurality of glass containers held by the capturing device in such a way that the outer container surface of the glass container is washed with a washing fluid, and in such a way that during this no washing fluid reaches the inner container surface of the glass container, and in such a way that the outer container surface of the glass container only comes into contact with materials which have a lower hardness than that of the glass container. Hardness of the glass container is understood to be the hardness of the glass material of the glass container. The hardness of any materials that may come into contact with the glass container is therefore lower than that of the glass material. To determine the hardness, the Mohs hardness can be used. In other words, it may be provided that the glass material can scratch the materials in contact with it.

Furthermore, the apparatus may comprise a processing station designed as a coating station for simultaneously coating the plurality of glass containers held by the capturing device in such a way that the outer container surface of the glass container is coated with a coating material, and in such a way that during this no coating material reaches the inner container surface of the glass container, and in such a way that the outer container surface of the glass container only comes into contact with materials which have a lower hardness than that of the glass container.

Furthermore, the apparatus may include a processing station designed as a homogenization station in order to simultaneously homogenize the coating on the plurality of glass containers held by the capturing device, such as, for example, smoothing and/or removing a drop of coating material formed at the container bottom, in particular in such a way that the outer container surface of the glass container, such as the container bottom, is immersed in a solvent or is brought to the surface of a solvent, in such a way that in the process no solvent reaches the inner container surface of the glass container, and in such a way that the outer container surface of the glass container comes into contact only with materials which have a lower hardness than that of the glass container.

Alternatively, the processing station designed as a homogenization station can comprise at least one smoothing device, such as a plurality corresponding to the plurality of glass containers, of smoothing devices, wherein the smoothing device is designed as a pointed rod and/or may consist of a material with a lower hardness than that of the glass container, in order to smooth and/or remove, such as simultaneously, on the plurality of glass containers held by the capturing device, a drop of coating material formed in each case on the container base, in such a way that the outer container surface of the glass container, such as the container bottom, is brought up to the smoothing device, and in such a way that the outer container surface of the glass container does not come into contact with the smoothing device.

Furthermore, the homogenization station can also include a suck-off device to homogenize the coating, e.g. to smooth and/or remove a drop of coating material formed at the container bottom. It is also possible that the homogenization station includes a device for moving the glass containers, such as a device for shaking and/or rotating the glass containers to achieve homogenization.

In addition, the apparatus may include a processing station designed as a drying station for simultaneously drying the plurality of glass containers held by the capturing device, in such a way that the outer container surface of the glass container comes into contact only with materials having a lower hardness than that of the glass container.

The capturing device of the apparatus may be arranged to hold the plurality of glass containers continuously during the processing steps to be carried out at the at least two processing stations and further during the transport from one processing station to the next processing station by the transport device.

In addition, the capturing device of the apparatus may be adapted to close the container opening of a glass container held by the capturing device by the sealing element continuously during the processing steps to be carried out at the at least two processing stations and further to close it during the transport from one processing station to the next processing station carried out by the transport device.

In order to ensure processing under clean room conditions, it may further be provided that the apparatus, such as the processing station designed as a washing station, the processing station designed as a coating station, the processing station designed as a homogenization station and/or the processing station designed as a drying station, comprises an air flow system for generating a laminar air flow.

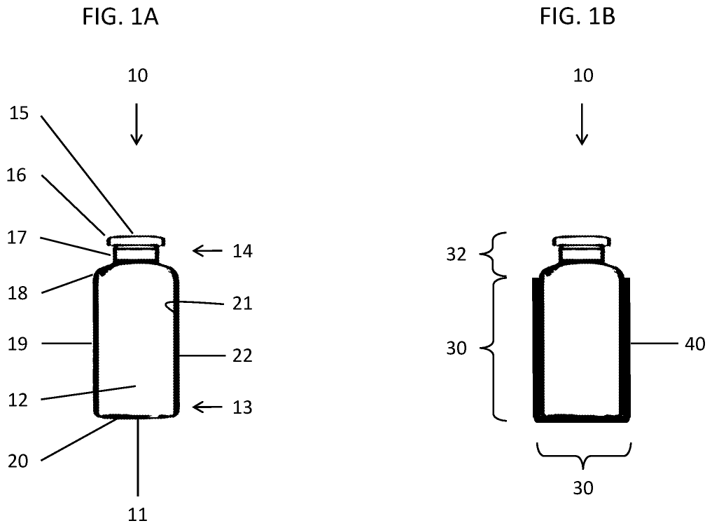

Referring now to the drawings, FIG. 1A shows an example of a glass container 10 designed as a vial for pharmaceutical, medical or cosmetic applications, comprising a hollow body 11 made of a glass material. The hollow body 11 surrounds an inner volume 12, and has a lower end 13 and an upper end 14, and a container opening 15 extends through the upper end 14 into the inner volume 12. The hollow body 11 further comprises a container collar 16 surrounding the container opening 15, a container neck 17, a container shoulder 18, a container body 19, a container bottom 20 closing the lower end 15, and an inner container surface 21 facing the inner volume 12 and an outer container surface 22 facing away from the inner volume 12.

FIG. 1B shows the glass container 10 from FIG. 1A, wherein the glass container 10 is coated on its outer container surface 22 with a coating 40 at least partially. In the example shown, the glass material of the hollow body 11 is covered with a coating 40 in the region of a coated partial area 30 of the outer container surface 22. The outer surface of the container is also uncoated partially. Therefore, the glass material of the hollow body 11 is exposed over an uncoated partial area 32 of the outer container surface 22. The inner container surface 21 is completely uncoated, i.e. the glass material of hollow body 11 is exposed over the entire inner container surface 21.

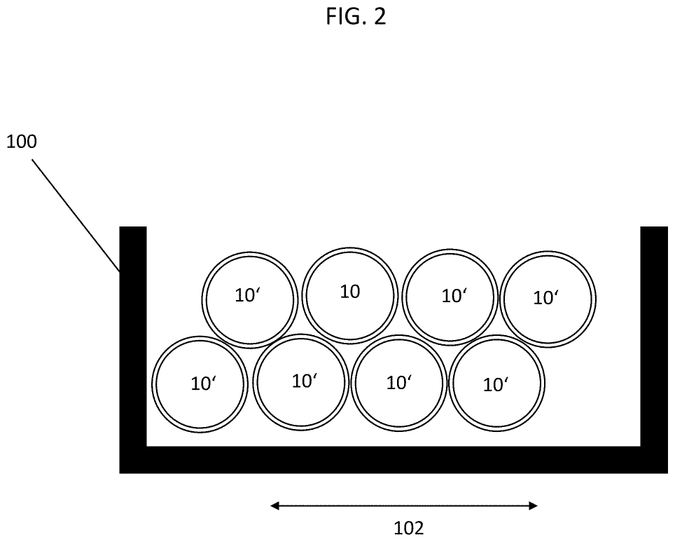

FIG. 2 shows a glass container 10 in a laboratory shaker 100, which is in contact with other glass containers 10′. It may be the shaker type KL2 from Edmund Baler GmbH. In the laboratory shaker 100, the glass containers lie, e.g. on a surface of 7.5×7.5 cm², sideways stacked on and next to each other, e.g. four containers below and four containers above. The glass container 10 is therefore in contact with other glass containers 10′ such that the container body 19 of glass container 10 touches the container body of some of the other glass containers 10′. The glass containers can be shaken in the laboratory shaker 100 for a period of at least 5 minutes, such as at least 10 minutes or at least 30 minutes, in radial direction 102. A shaking frequency of 400 rpm and an amplitude of 1 cm can be used. Prior to shaking, the glass containers may be heated at 350° C. for 30 minutes and may be immersed in a bath of distilled water at a temperature of 80° C. for 5 minutes before heating.

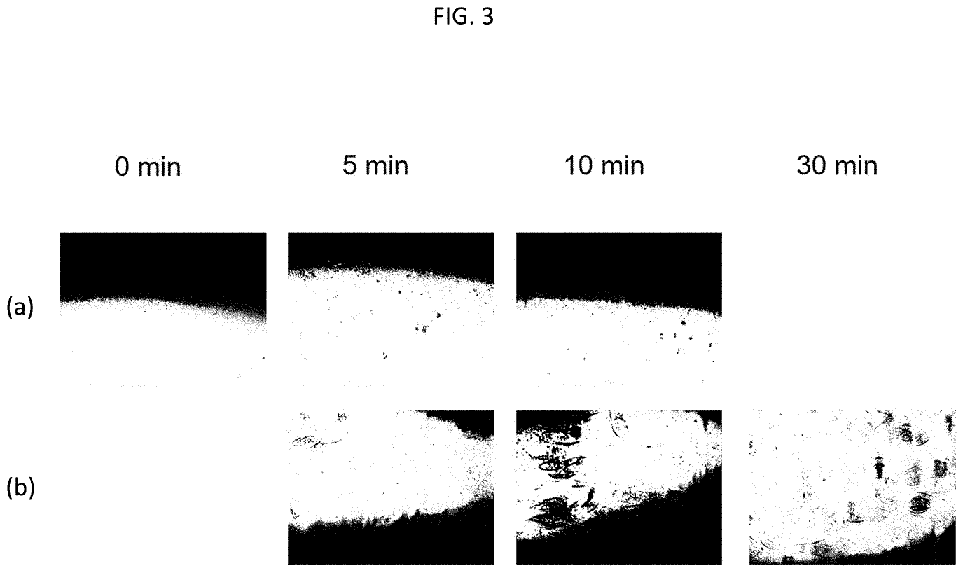

The side designated (a) of FIG. 3 shows a photographs of a glass container coated on its outer container surface at least partially with a coating, which was in contact with further glass containers as described above for different periods of time, while the side designated (b) of FIG. 3 shows corresponding photographs of a known glass container, wherein the glass containers were again in contact as described previously for different periods of time. As can be seen, the coated glass container shows increased scratch resistance.

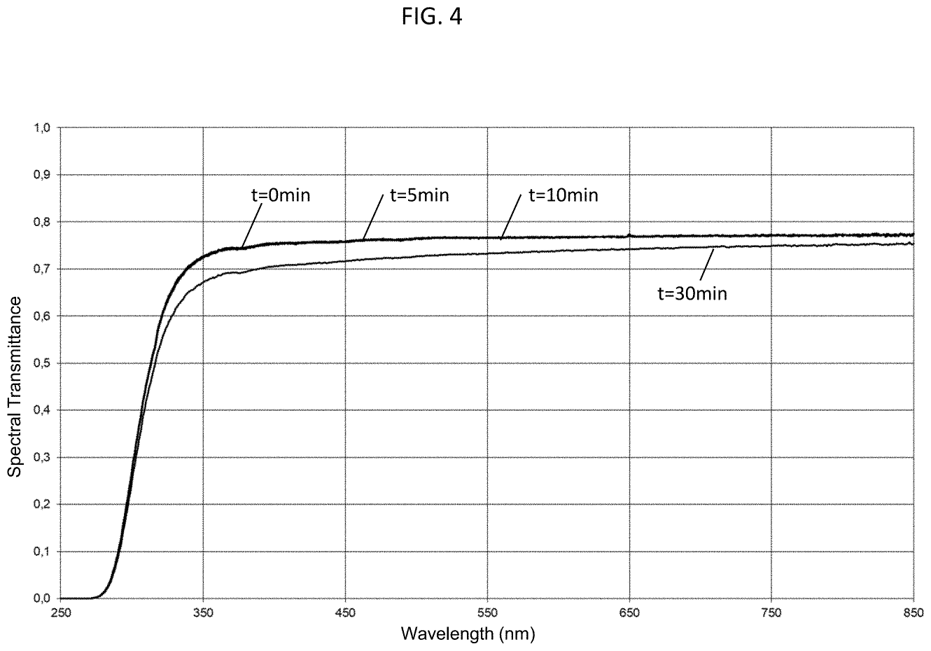

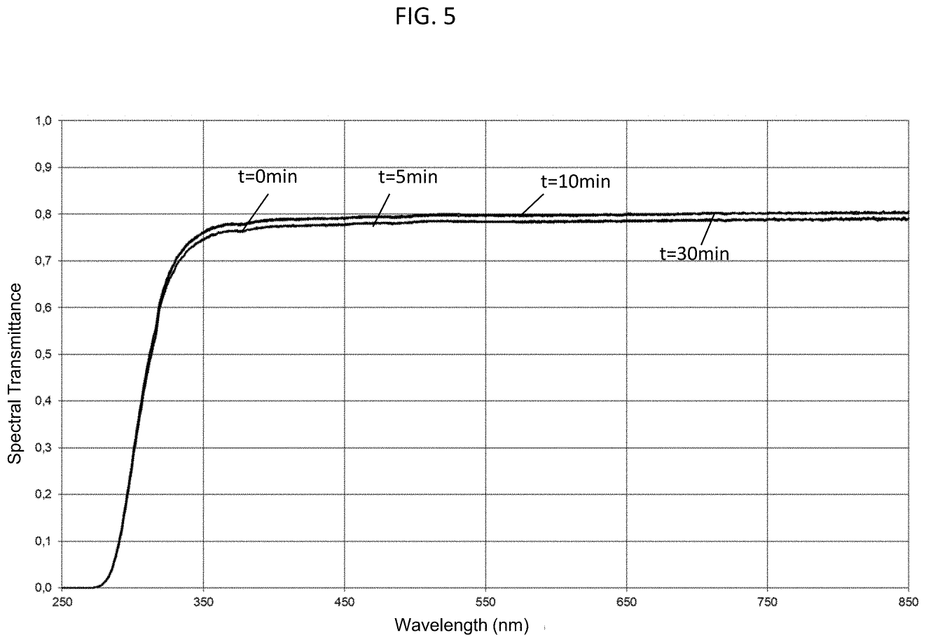

FIG. 4 shows the spectral transmittance of a known glass container which was in contact with other glass containers as described previously for different periods of time, while FIG. 5 shows the corresponding transmittance of a glass container coated on its outer surface at least partially with a coating, wherein the glass containers again were in contact in particular as described previously for different periods of time. As can be seen, at a wavelength of 350 nm, the coated glass container is characterized by a transmittance which is higher than 0.7, such as higher than 0.71, higher than 0.72, higher than 0.73, or higher than 0.74. At a wavelength of 550 nm the transmission is higher than 0.73, such as higher than 0.74, higher than 0.75, higher than 0.76, or higher than 0.77 and at a wavelength of 750 nm the transmission is higher than 0.74, such as higher than 0.75, higher than 0.76, higher than 0.77, or higher than 0.78.

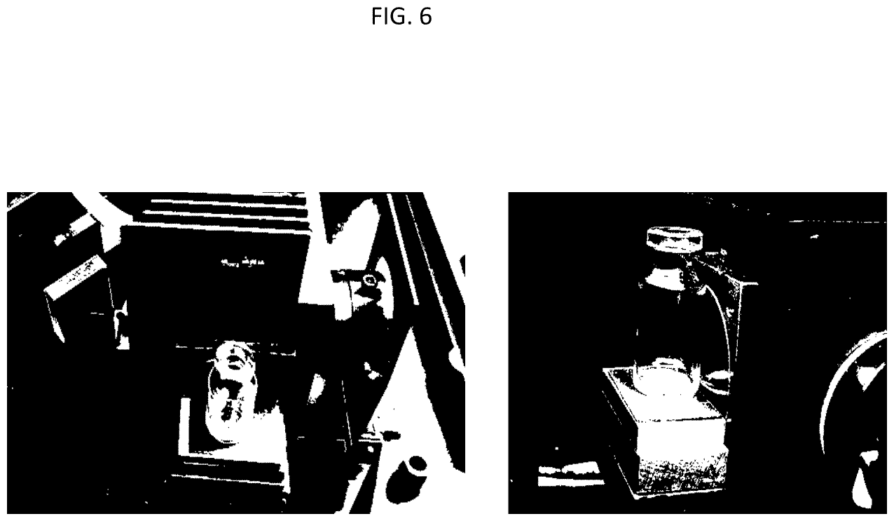

The transmission can be measured e.g. directly above the bottom of the container 20, as can be seen in the device shown in FIG. 6, in which the light (aperture diameter 5 mm) passes through the container 3 mm above the bottom and crosses the container wall twice.

The device shown in FIG. 6 can also be used to measure the yellowness index of the glass container according to ASTM D1925-70, wherein the glass containers again were in contact for different periods of time, in particular as described previously. For example, the following values could be determined:

| | | | |
|---|---|---|---|
| 0 min | 5 min | 10 min | 30 min |

Coated containers, “standard lighting type C”:

| | | | | |
|---|---|---|---|---|
| x | 0.3106 | 0.3106 | 0.3106 | 0.3106 |
| y | 0.3171 | 0.3171 | 0.3171 | 0.3170 |
| Y | 78.3 | 79.9 | 78.5 | 79.6 |
| Yellowness | 0.9 | 0.9 | 0.9 | 0.9 |

Uncoated containers, “standard lighting type C”:

| | | | | |
|---|---|---|---|---|
| x | 0.3108 | 0.3110 | 0.3110 | 0.3125 |
| y | 0.3173 | 0.3174 | 0.3175 | 0.3188 |
| Y | 76.7 | 76.6 | 76.7 | 73.3 |
| Yellowness | 1.1 | 1.3 | 1.4 | 2.9 |

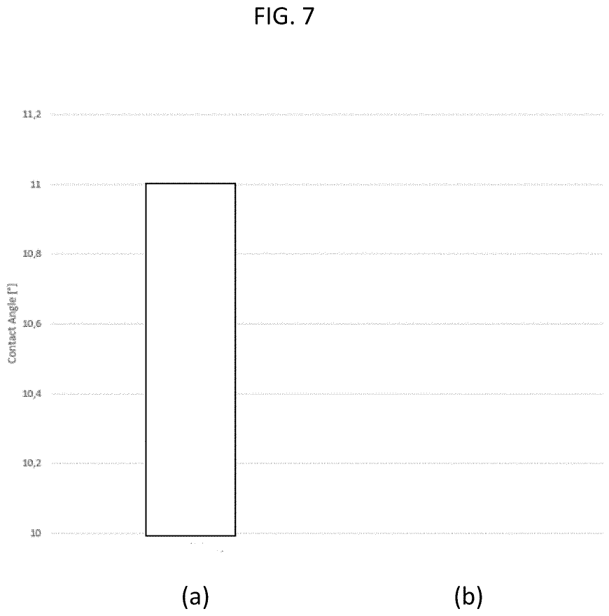

FIG. 7, on the side designated (a), shows measurement results of the contact angle of n-hexadecane, which was applied in the form of drops in the region of the coated partial area 30 on the outer container surface 22 of the partially coated glass container 10 shown in FIG. 1B. As can be seen, the partially coated glass container 10 is characterized by the fact that the coated partial area 30 of the outer container surface 22 forms a contact angle between 10 and 12 degrees with respect to n-hexadecane.

For comparison, FIG. 7, on the side designated (b), shows measurement results of the contact angle of n-hexadecane, which was applied as a drop at a comparable position on the outer container surface 22 of the uncoated glass container 10 shown in FIG. 1A. The contact angle is smaller than 10 degrees, i.e. the applied drop is distributed so flat on the container surface that the contact angle is almost impossible to measure.

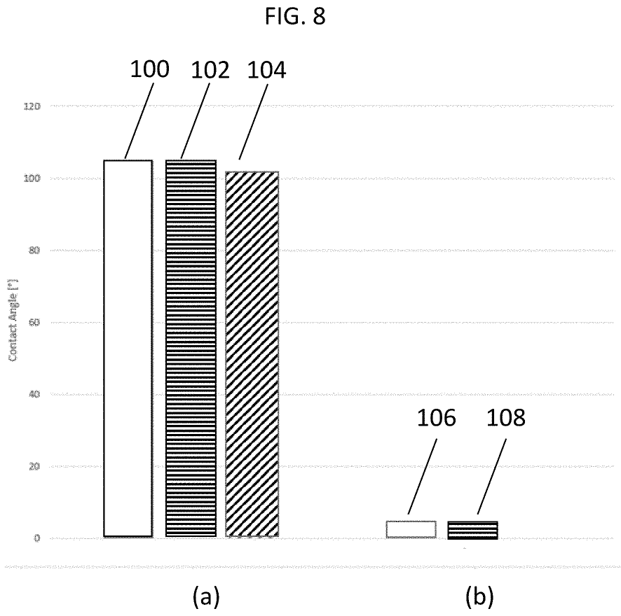

FIG. 8, one the side designated (a), shows measurement results of the contact angle of water applied as drops in the area of the coated partial surface 30 on the outer container surface 22 of the partially coated glass container 10 shown in FIG. 1B. As can be seen, the partially coated glass container 10 is characterized by the fact that the coated partial surface 30 of the outer container surface 22 forms a contact angle between 90 and 120 degrees with respect to water. The graph labeled 100 shows measurement results for a glass container 10, which was washed, coated and dried, while the graph labeled 102 shows measurement results for a glass container 10, which was additionally thermally treated at 350° C. for 1 hour, analogous to a depyrogenation process, and the graph labeled 104 shows measurement results for a glass container 10, which was washed again after the thermal treatment.

FIG. 8, on the side designated (b), again shows for comparison measurement results of the contact angle of water, which was applied in the form of drops at a comparable position on the outer container surface 22 of the uncoated glass container 10 shown in FIG. 1A. The contact angle is smaller than 10 degrees or almost disappearing, i.e. the applied drop is distributed so flat on the container surface that the contact angle almost disappears. The graph labeled 106 shows measurement results for an untreated glass container 10, while the graph labeled 108 shows measurement results for an uncoated glass container 10 that has been thermally treated.

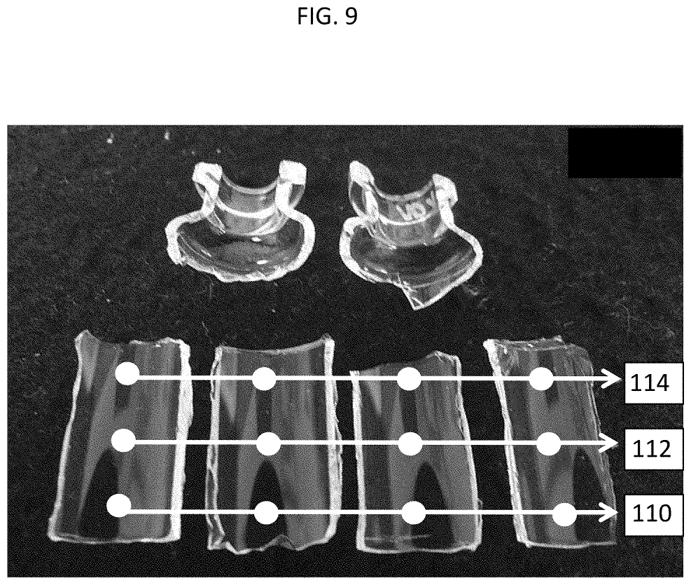

FIG. 9 shows several test points 110, 112, 114 on the inner container surface of the partially coated glass container 10 with partially coated outer container surface shown in FIG. 1B. At the test points shown, the contact angle of n-hexadecane and water, respectively, with the inner container surface was determined. The contact angle is smaller than 10 degrees in each case, i.e. the applied drop is distributed so flatly on the container surface that the contact angle is almost impossible to measure. This corresponds to the measurement results known from sides (b) of FIGS. 7 and 8 for the uncoated glass container 10. The glass container coated on the outer container surface is therefore completely uncoated on the inner container surface.

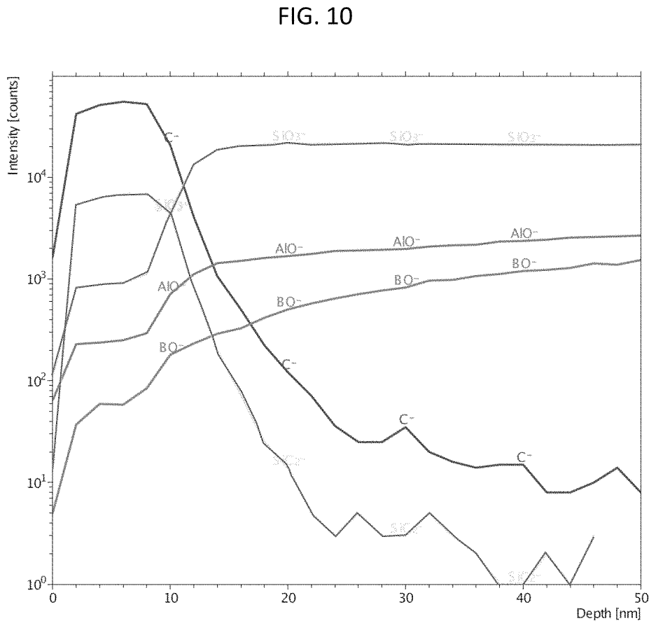

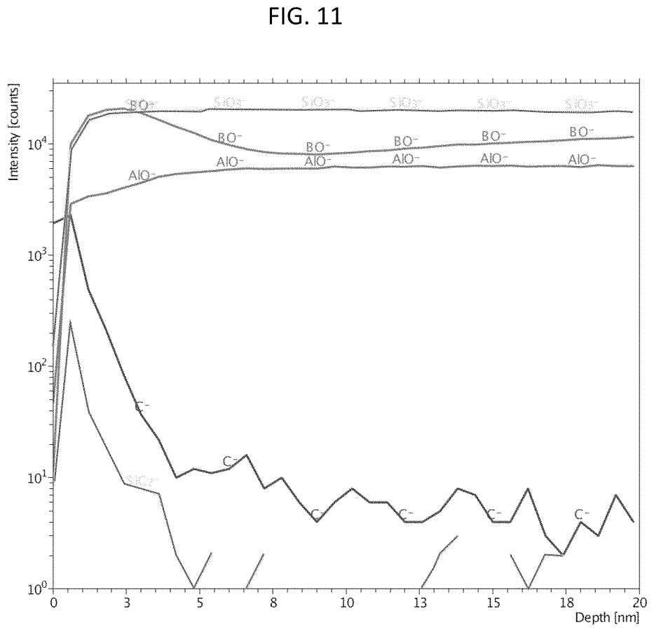

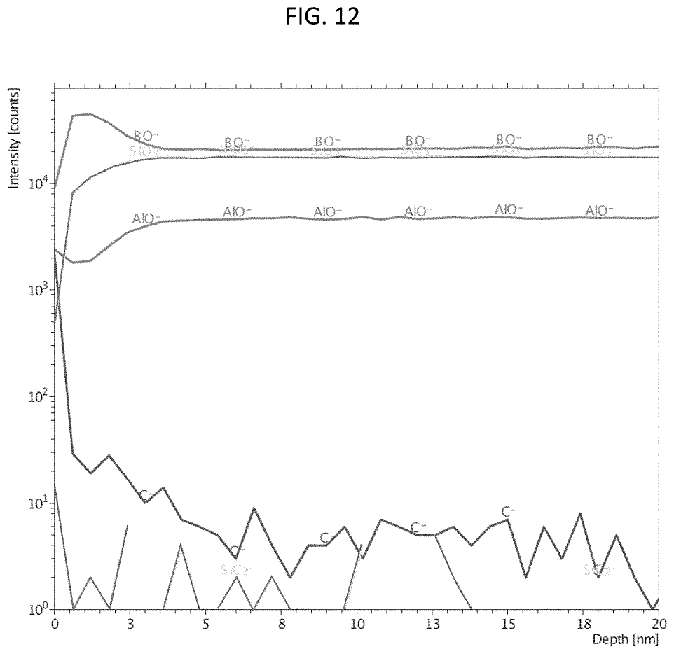

FIGS. 10 to 12 show depth profiles of selected secondary ions at various locations on the container surface of the partially coated glass container 10 shown in FIG. 1B, wherein the depth profiles are given in the form of an equivalent thickness and are acquired using secondary ion mass spectrometry (ToF-SIMS). The equivalent thickness is determined by first determining a sputter rate using secondary ion mass spectrometry (ToF-SIMS) with sputter parameters Cs and 2 keV on the basis of the reference glass BK7 and then using this sputter rate to determine the depth profiles. The measurement results shown in FIG. 10 refer to the outer container surface at the bottom of the container, the measurement results shown in FIG. 11 refer to the outer container surface centered on the container body and the measurement results shown in FIG. 12 refer to the inner container surface centered on the container body.

As can be seen from FIGS. 10 and 11 for the container bottom and the container body on the outside of the glass container, the curves for C— and SiC₂—, which serve as a signal for the coating, fall with increasing depth, while the curves for SiO₃—, AlO— and BO—, which serve as a signal for the glass material, rise with increasing depth. Furthermore, FIG. 12 shows that the curves for C— and SiC₂—, which serve as a signal for coating, do not show any measurable intensity. It can be seen from this that the partially coated glass container 10 is characterized in that the coating, which covers the outer container surface 22 in the area of the container bottom 20, has an equivalent thickness of less than 200 nm, such as less than 100 nm, less than 50 nm, or less than 25 nm, and in that the coating which covers the outer container surface 22 in the region of the container body 19 has an equivalent thickness of less than 50 nm, such as of less than 25 nm, of less than 10 nm, or of less than 5 nm, and in that the inner container surface 21 is completely uncoated, i.e. the glass material is exposed over the entire inner container surface 21.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass container, comprising:
a hollow body of a glass material, the hollow body surrounding an inner volume and having a lower end and an upper end, a container opening extends through the upper end into the inner volume, the hollow body further comprising a container collar surrounding the container opening, a container neck, a container shoulder, a container body, a container bottom closing the lower end, and an inner container surface facing the inner volume and an outer container surface facing away from the inner volume, the glass container being coated on its outer container surface at least partially with a coating and the coated glass container has an increased scratch resistance with respect to a contact of the glass container with at least one further glass container.

2. The glass container of claim 1, wherein the contact of the glass container with at least one further glass container comprises a contact in which the container body of the glass container is in contact with a container body of at least one further glass container of the same type.

3. The glass container of claim 2, wherein the contact comprises shaking the glass containers and before the shaking the glass containers are heated for 1 min to 60 min to 100° C. to 600° C.

4. The glass container of claim 3, wherein less than 8 hours has passed between the heating and the shaking.

5. The glass container of claim 3, wherein before the heating the glass containers are immersed in a bath of at least one of water or distilled water at a temperature of 40° C. to 100° C. for 1 s to 20 min.

6. The glass container of claim 1, wherein the glass container has a transmittance for light with a wavelength of 350 nm which is higher than 0.7, wherein the transmittance is measurable at least at one point in a region of the container body when the light passes radially and centrally through the glass container such that the light first passes through the hollow body, then through the inner volume, and then again through the hollow body, and wherein the glass container has the transmittance after contact of the glass container with at least one further glass container.

7. The glass container of claim 1, wherein the glass container has a transmittance for light with a wavelength of 550 nm which is higher than 0.73, wherein the transmittance is measurable at least at one point in a region of the container body when the light passes radially and centrally through the glass container such that the light first passes through the hollow body, then through the inner volume, and then again through the hollow body, and wherein the glass container has the transmittance after contact of the glass container with at least one further glass container.

8. The glass container of claim 1, wherein the glass container has a transmittance for light with a wavelength of 750 nm which is higher than 0.74, wherein the transmittance is measurable at least at one point in a region of the container body when the light passes radially and centrally through the glass container such that the light first passes through the hollow body, then through the inner volume, and then again through the hollow body, and wherein the glass container has the transmittance after contact of the glass container with at least one further glass container.

9. The glass container of claim 1, wherein the glass container has a yellowness index which is lower than 2.5, wherein the yellowness index is measurable at least at one point in a region of the container body according to ASTM D1925-70 when light passes radially and centrally through the glass container such that the light first passes through the hollow body, then through the inner volume, and then again through the hollow body, and wherein the glass container has the yellowness index after contact of the glass container with at least one further glass container.

10. The glass container of claim 1, wherein the outer container surface of the glass container has a mean roughness Rₐ which is lower than 20 nm, wherein the mean roughness value Rₐ is measurable at least at one point in a region of the container body by white light interference microscopy, and wherein the glass container has the mean roughness Rₐ after contact of the glass container with at least one further glass container.

11. The glass container of claim 1, wherein the coating with which the outer container surface is at least partially coated comprises a silicone.

12. The glass container of claim 1, wherein the outer container surface is coated with the coating such that the glass material of the hollow body is covered with the coating in a region of a coated partial area of the outer container surface and the outer container surface is partially uncoated such that the glass material of the hollow body is exposed over an uncoated partial area of the outer container surface, the inner container surface is completely uncoated such that the glass material of the hollow body is exposed over the entire inner container surface, and the coating covering the outer container surface in the region of the coated partial area is characterized by an adhesion to the glass material or is configured such that no migration of coating material onto the inner container surface occurs after storage of the container for at least 1 week.

13. The glass container of claim 1, wherein a coated partial surface of the outer container surface encloses a region of the container body and a region of the container bottom at least partially, an uncoated partial area of the outer container surface corresponds to the entire outer container surface minus the coated partial area of the outer container surface, and the uncoated partial area of the outer container surface completely encloses a region of the container collar.

14. The glass container of claim 13, wherein the coated partial surface of the outer container surface encloses the region of the container body and the region of the container bottom completely.

15. The glass container of claim 13, wherein the uncoated partial area of the outer container surface completely encloses a region of the neck.

16. The glass container of claim 1, wherein the coating, which covers the outer container surface in a region of the container body, has at least at one point an equivalent thickness related to the glass material of less than 50 nm, wherein the equivalent thickness related to the glass material is determinable by determining a sputter rate by secondary ion mass spectrometry (ToF-SIMS) on the basis of a reference glass and using this sputter rate for evaluating the secondary ion mass spectrometry of the coating.

17. The glass container of claim 1, wherein the coating, which covers the outer container surface in a region of the container bottom, has at least at one point an equivalent thickness related to the glass material of less than 200 nm, wherein the equivalent thickness related to the glass material is determinable by determining a sputter rate by secondary ion mass spectrometry (ToF-SIMS) on the basis of a reference glass and using this sputter rate for evaluating the secondary ion mass spectrometry of the coating.

18. The glass container of claim 1, wherein an equivalent thickness of the coating which covers the outer container surface in a region of the container body and an equivalent thickness of the coating which covers the outer container surface in a region of the container bottom are in a ratio to one another which is in a range from 1:10 to 10:1, wherein the equivalent thickness related to the glass material is determinable by determining a sputter rate by secondary ion mass spectrometry (ToF-SIMS) on the basis of a reference glass and using this sputter rate for evaluating the secondary ion mass spectrometry of the coating.

19. The glass container of claim 1, wherein a coated partial surface of the outer container surface forms a contact angle between 10 and 12 degrees with respect to hexadecane and an uncoated partial surface of the outer container surface forms a contact angle of less than 10 degrees with respect to hexadecane.

20. A glass container for pharmaceutical, medical or cosmetic applications, comprising:
a hollow body of a glass material, the hollow body surrounding an inner volume and having a lower end and an upper end, a container opening extending through the upper end into the inner volume, and the hollow body further comprising a container collar surrounding the container opening, a container neck, a container shoulder, a container body, a container bottom closing the lower end, and an inner container surface facing the inner volume and an outer container surface facing away from the inner volume, the glass container being coated on its outer container surface at least partially with a coating, the outer container surface being partially uncoated such that the glass material of the hollow body is exposed over an uncoated partial area of the outer container surface, and the inner container surface being completely uncoated such that the glass material of the hollow body is exposed over the entire inner container surface, the coating covering the outer container surface in a region of a coated partial area is characterized by an adhesion to the glass material or is configured such that no migration of coating material onto the inner container surface occurs after storage of the container for at least 1 week.
